(19) United States
(12) Patent Application Publication
(10) Pub. No.: US 2011/0093410 A1
(43) Pub. Date: Apr. 21, 2011

(54) METHOD FOR PREPARING A CHICKEN THIGH PRODUCT

(76) Inventor: Alan Knuckman, Chicago, IL (US)

(21) Appl. No.: 12/580,158

(22) Filed: Oct. 15, 2009

(51) Int. Cl. A23L 1/318; G06Q 90/00; A23B 4/056

(52) U.S. Cl. 705/500; 452/125; 426/312; 426/235; 426/644

(57) ABSTRACT

Aspects of a method for preparing a chicken thigh product are provided. In this regard, a chicken thigh product may be prepared by seasoning and smoking a skinless bone-in oyster-cut chicken thigh, where the skinless bone-in oyster-cut chicken thigh comprises a thigh bone, thigh meat, and oyster meat. Preparing the chicken thigh product may comprise separating an uncooked chicken leg from an uncooked chicken carcass such that the oyster meat is separated from the pelvis of the uncooked chicken carcass and remains attached to the uncooked chicken leg. The skinless bone-in oyster-cut chicken thigh may be smoked until a texture of the skinless bone-in oyster-cut chicken thigh is substantially similar to the texture of cooked pork ribs.

### CROSS-REFERENCE TO RELATED APPLICATIONS/INCORPORATION BY REFERENCE

Not Applicable

### FIELD OF THE INVENTION

Certain embodiments of the invention relate to food preparation. More specifically, certain embodiments of the invention relate to a method for preparing a chicken thigh product.

### BACKGROUND OF THE INVENTION

It is no secret that obesity and the health problems that come along with being overweight are a major problem in the world today. However, even as the world becomes more health conscious, there are many factors that prevent people from eating healthier food. In this regard, as people's life become increasingly hectic they rely more and more on restaurant, fast food, and frozen food. However, in many instances, the options are lacking either nutritionally or in terms of taste. Moreover, even when healthier options are available, they are often significantly more expensive than the high-fat, high-cholesterol, high-preservative, high-sugar-content options. Additionally, people often enjoy the experience of eating particular foods and/or find comfort or pleasure in certain dining experiences and thus do not want to give up those experiences.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A method is provided for preparing a chicken thigh product, substantially as illustrated by and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIGS. 1-3 illustrate steps in a process for preparing a chicken thigh product, in accordance with an embodiment of the invention.

FIG. 4 is a diagram illustrating packaging a chicken thigh product, in accordance with an embodiment of the invention.

FIGS. 6A and 6B illustrating serving a chicken thigh product, in accordance with an embodiment of the invention.

FIG. 7 is a flow chart illustrating exemplary steps for preparing a chicken thigh product, in accordance with an embodiment of the invention.

### DETAILED DESCRIPTION OF THE INVENTION

Certain embodiments of the invention may be found in a method for preparing a chicken thigh product. In various embodiments of the invention, a chicken thigh product may be prepared by seasoning and smoking a skinless bone-in oyster-cut chicken thigh, where the skinless bone-in oyster-cut chicken thigh comprises a thigh bone, thigh meat, and oyster meat. Preparing the chicken thigh product may comprise separating an uncooked chicken leg from an uncooked chicken carcass such that the oyster meat is separated from the pelvis of the uncooked chicken carcass and remains attached to the uncooked chicken leg. Preparing the chicken thigh product may comprise cutting across the knee joint of a chicken leg such that the chicken leg is separated into a thigh and a drumstick. Preparing the chicken thigh product may comprise removing any skin from a chicken thigh.

The skinless bone-in oyster-cut chicken thigh may be smoked until an internal temperature of the skinless bone-in oyster-cut chicken thigh is at least 180°. The chicken thigh product may be frozen after smoking, and may be reheated in one of a conventional oven, a microwave oven, and a grill until said skinless bone-in oyster-cut chicken thigh is a desired temperature. The skinless bone-in oyster-cut chicken thigh may be smoked until a texture of the skinless bone-in oyster-cut chicken thigh is substantially similar to the texture of cooked pork ribs. The chicken thigh product may be placed in a package that indicates a quantity of the chicken thigh products therein. The quantity may be indicated as an integer and/or fractional number of slabs, where a slab may correspond to a quantity of two or more of the chicken thigh products.

In various embodiments of the invention, a chicken thigh may be cut, seasoned, and smoked to create a chicken thigh product that has a taste and texture that imitates pork or beef ribs. The chicken thigh product may be marketed or offered for sale under a product name that references or implies pork ribs or beef ribs. The chicken thigh product may be sold in integer or half-integer multiples of a slab, where a slab comprises two or more of the chicken thigh products.

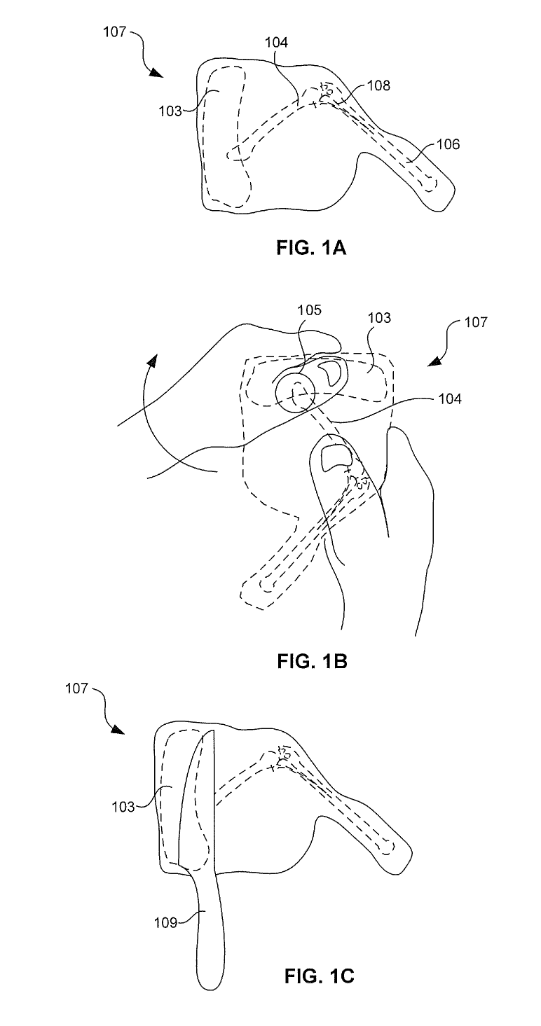

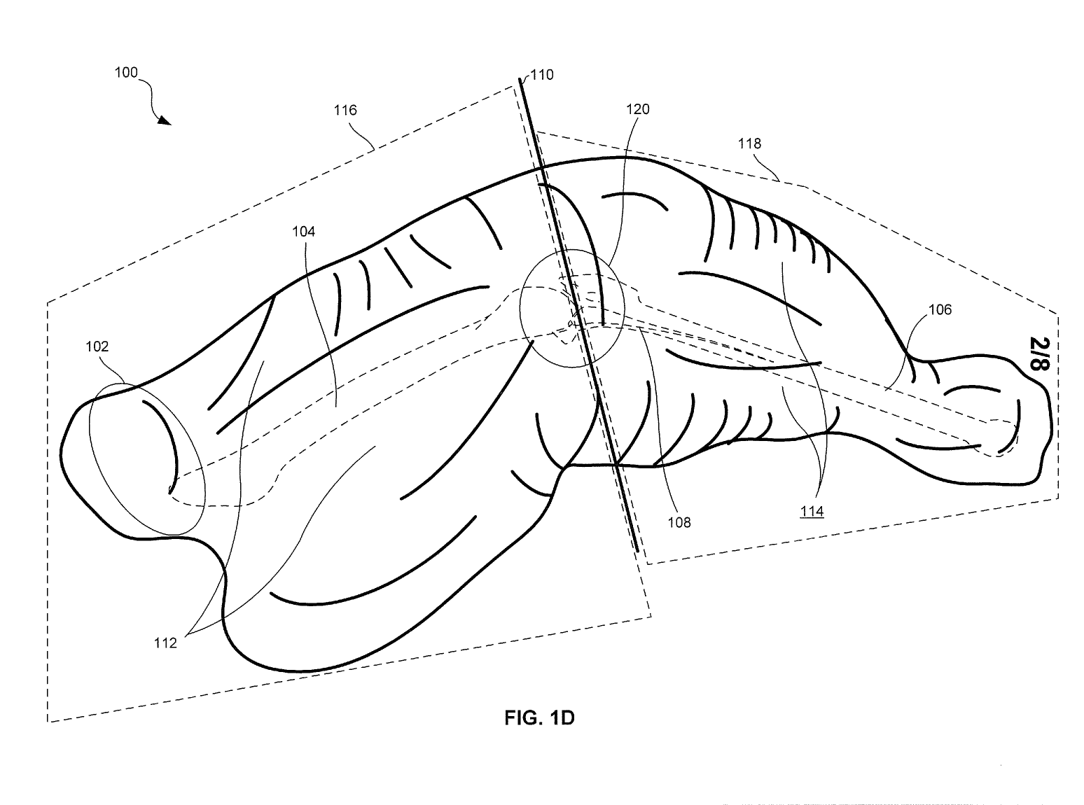

FIGS. 1-3 illustrate steps in a process for preparing a chicken thigh product, in accordance with an embodiment of the invention. Referring to FIG. 1A there is shown an uncooked chicken leg quarter 107 comprising pelvic bone 103, a femur bone 104, a tibia bone 106, a fibula bone 108, and associated meat and skin. Referring to FIG. 1B, there is shown a first step in removing the pelvic bone 103 from the chicken leg quarter 107, while maximizing the meat that is separated from the pelvic bone 103 and attached to the chicken leg quarter 107. In this regard, FIG. 1B illustrates breaking or popping the femur bone out of the hip socket 105 by: holding the pelvic bone 103 in one hand, holding the femur bone 104 in the other hand, and bending or rotating the pelvic bone 103 such that the hip socket rotates away from the femur bone 104. Referring to FIG. 1C, after the femur bone 104 has been separated from the hip socket 105, a knife 109 or other cutting apparatus may be utilized to separate the pelvic bone 103 from the chicken leg. In this regard, the knife 109 may cut underneath the pelvic bone 103, between the pelvic bone 103 and the femur bone 104, following the contours of the pelvic bone 103. In this manner, the pelvic bone 103 may be separated from the chicken leg such that as much meat as possible, including the “oyster” meat, remains attached to the chicken leg. The result of removing the pelvic bone 103 is an oyster-cut chicken leg 100, as is described with respect to FIG. 1D below.

Referring to FIG. 1D there is a shown oyster-cut chicken leg 100 comprising oyster meat 102, femur bone 104, tibia bone 106, fibula bone 108, thigh meat 112, and drumstick meat 114. The oyster-cut chicken leg 100 has been removed from the chicken carcass (not shown) via a cut that ensures the oyster meat 102 remains with the chicken leg 100. In this regard, the oyster meat 102 is a portion of meat located near the joint where the thigh bone connects to the pelvis. Also shown in FIG. 1D, is a line 110 indicating a cut that may be made across the knee joint 120 in a direction generally perpendicular to the femur bone 104. In this manner, the cut across the knee joint may separate the chicken leg 100 into a bone-in oyster-cut chicken thigh 116 and a drumstick 118. In this regard, the bone-in oyster-cut chicken thigh 116 may comprise a thigh bone 104, thigh meat 112, and oyster meat 102.

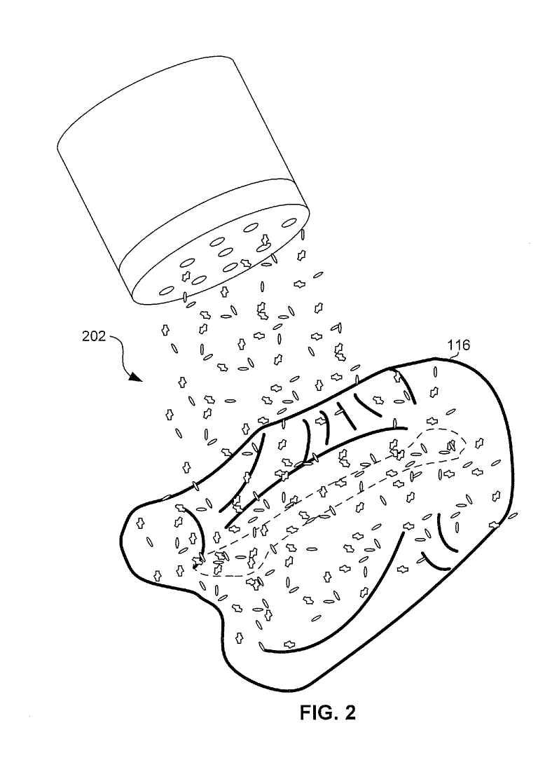

Referring to FIG. 2, the skin may be removed from the bone-in oyster-cut chicken thigh 116 of FIG. 1, and the skinless bone-in oyster-cut chicken thigh 116 may be seasoned with seasoning 202. The seasoning 202 may comprise one or more herbs, spices, sauces, pastes, grains, fruits, vegetables, or any other seasoning ingredient. In an exemplary embodiment of the invention, the seasoning 202 may be a mixture of substantially dry ingredients and may be referred to as a “rub”.

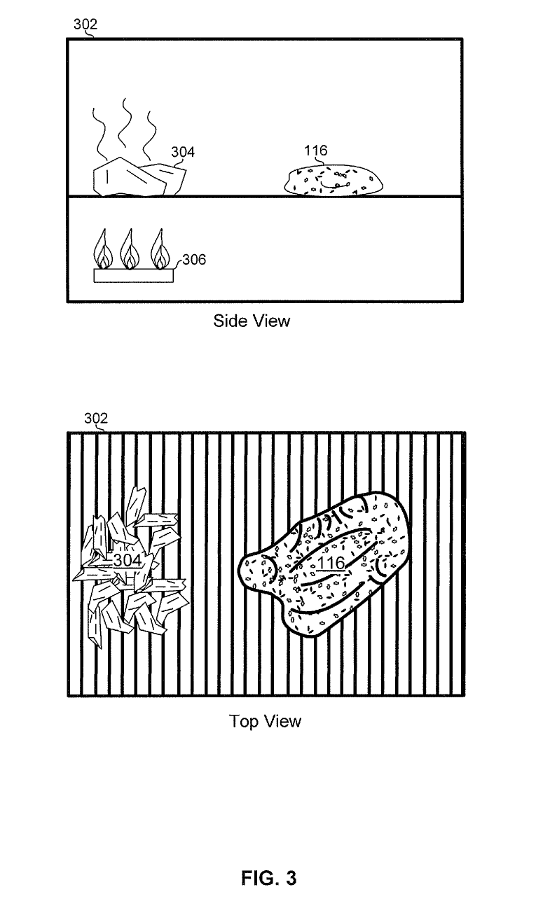

Referring to FIG. 3, the skinless bone-in oyster-cut chicken thigh 116 may be smoked in a smoking apparatus 302. The smoking apparatus 302 may comprise any suitable smoking apparatus. In one embodiment of the invention, during smoking, the heat source 306 may directly heat the wood 304, which may have been previously soaked with water, to cause the wood 304 to smoke. The skinless bone-in oyster-cut chicken thigh 116 may be situated such that it does not receive direct heat from the heat source, but rather, is cooked via the smoke and heat that accumulates in the smoking apparatus 302. Additionally or alternatively, the smoking apparatus 302 may comprise a pressure smoker.

In one exemplary embodiment of the invention, and the skinless bone-in oyster-cut chicken thigh 116 may be smoked until a temperature of the skinless bone-in oyster-cut chicken thigh 116, measured at approximately the center of what is approximately the thickest part of the skinless bone-in oyster-cut chicken thigh 116, is at least 180° F. In this regard, although chicken is conventionally cooked until it is approximately 170° F., and, in fact, chicken cooked above 180° is conventionally considered burned or undesirable, smoking the skinless bone-in oyster-cut chicken thigh 116 to a temperature of at least 180° F. results in a chicken thigh product 216 which has the taste and texture of pork or beef ribs. Also, the manner of eating the chicken thigh meat from the thigh bone may be reminiscent of eating pork or beef ribs. Thus, the taste, texture, and manner of eating the chicken thigh product may combine to create an experience substantially similar to eating pork or beef ribs.

In various embodiments of the invention, the chicken thigh product 216 may be refrigerated prior to smoking, and may be placed in the smoking apparatus 302 while still below room temperature. In other embodiments of the invention, the chicken thigh product 216 may be brought up to room-temperature before being placed in the smoking apparatus 302.

Although FIGS. 1-4 illustrate preparing the chicken thigh product 216 via a manual process, the invention is not so limited. In this regard, one or more machines and/or automated processes may be utilized to, for example, remove the chicken leg from the chicken carcass, separate bone-in oyster-cut chicken thigh 116 and the drumstick 118, season the chicken thigh products 216, smoke the chicken thigh products 216, freeze the chicken thigh products 216, and/or package the chicken thigh products 216. In one embodiment of the invention, the bone-in oyster-cut chicken thigh 116 may be seasoned in a tumbler and the bone-in oyster-cut chicken thigh 116 may be smoked in a high pressure smoker.

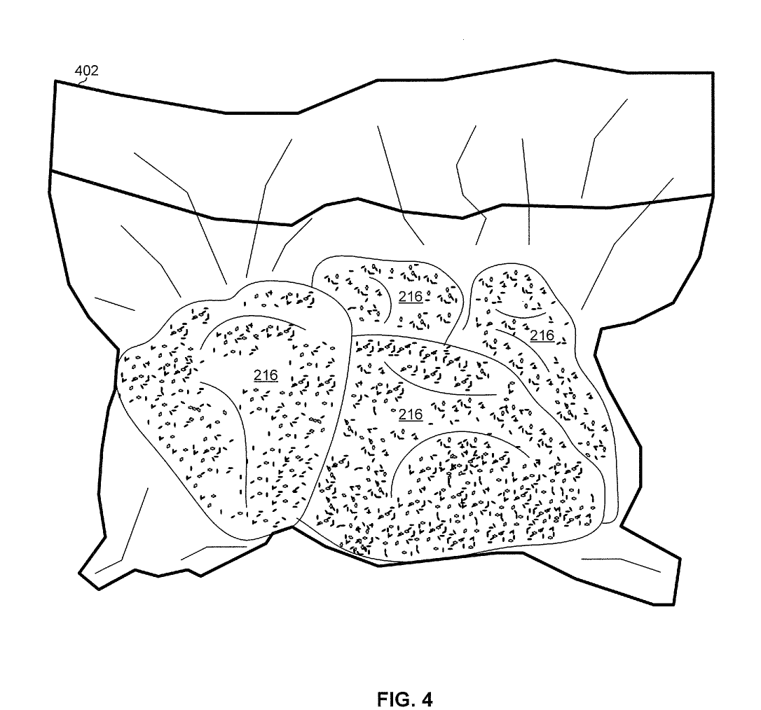

FIG. 4 is a diagram illustrating packaging of one or more chicken thigh products, in accordance with an embodiment of the invention. Referring to FIG. 4 there is shown a plurality of smoked chicken thigh products 216 packaged in a bag 402. In an exemplary embodiment of the invention, the chicken thigh products 402 may be vacuum sealed in the bag 402. The bag 402 may comprise, for example, plastic and/or metallic materials. The bag 402 may be re-sealable. In an exemplary embodiment of the invention, the bag 402 may comprise materials suitable for use in a microwave and/or conventional oven such that the chicken thigh products 216 may be reheated without removing them from the bag 402. In various embodiments of the invention, the bag 402 containing the chicken thigh product 216 may be further packaged into a stackable container that is made from, for example, cardboard or plastic. In other embodiments of the invention, the chicken thigh product 216 may be packaged in a stackable container without first being placed in a bag 402.

In various embodiments of the invention, the chicken thigh products 216 may be marketed or offered for sale in multiples of half and full “slabs”, as pork and beef ribs are often marketed or offered for sale. In this regard, a quantity N of the chicken thigh product 216 may be marketed or offered for sale as half of a “slab,” a quantity 2N may be marketed or offered for sale as a full “slab,” 3N as one and a half “slabs,” 4N as two “slabs,” and so forth. Accordingly, packaging such as the bag 402, or a stackable container in which the chicken thigh product is packaged, may be marked as containing a certain integer and/or fractional number of “slabs.” Similarly, a menu or other advertising or marketing in a food serving establishment may offer the chicken thigh product 216 for sale in portions corresponding to integer and/or fractional numbers of “slabs.” Referring to quantities of the chicken thigh product 216 in terms of half and full “slabs,” may associate, in a consumer's mind, the chicken thigh products 216 with pork or beef ribs. In this regard, the chicken thigh product 216 may provide a desirable substitute for beef or pork ribs to consumers who enjoy pork or beef ribs but desire a food with lower fat content than port or beef ribs.

In an exemplary embodiment of the invention, a half slab may comprise two chicken thigh products 216, as depicted in FIG. 5A, and a full slab may comprise four chicken thigh products 216, as depicted in FIG. 5B. The chicken thigh products 216 may be served in or on any suitable serving apparatus and may be accompanied by one or more side dishes 506, such as fries or melon, and one or more dipping sauces 504.

In various embodiments of the invention, the chicken thigh products 216 may be marketed or offered for sale under a product or brand name that associates the chicken thigh products 216 with pork or beef ribs. For example, the chicken thigh product 216 may be branded, offered for sale, or otherwise marketed as Chicken Ribs™. In this regard, the combination of the pork rib or beef rib like taste and texture, the manner of eating the chicken thigh product as if it were a rib, the ordering of the chicken thigh product in units of slabs or half slabs, and the branding of the chicken thigh product create the overall experience of a BBQ rib dinner.

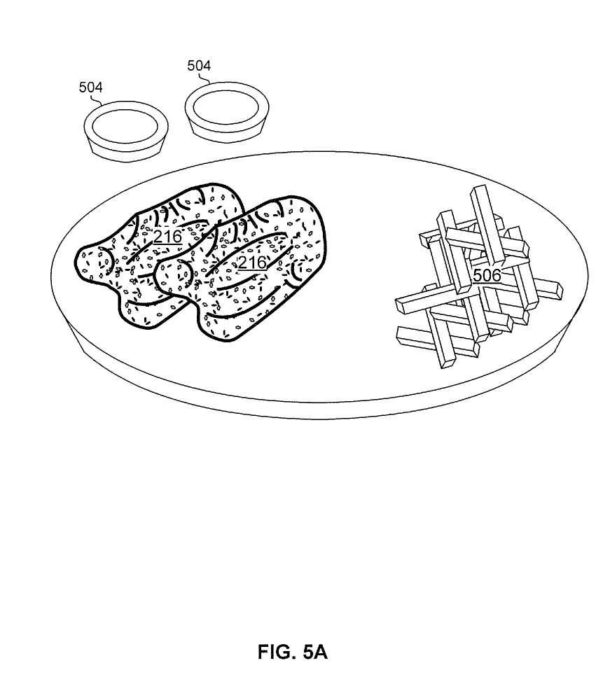

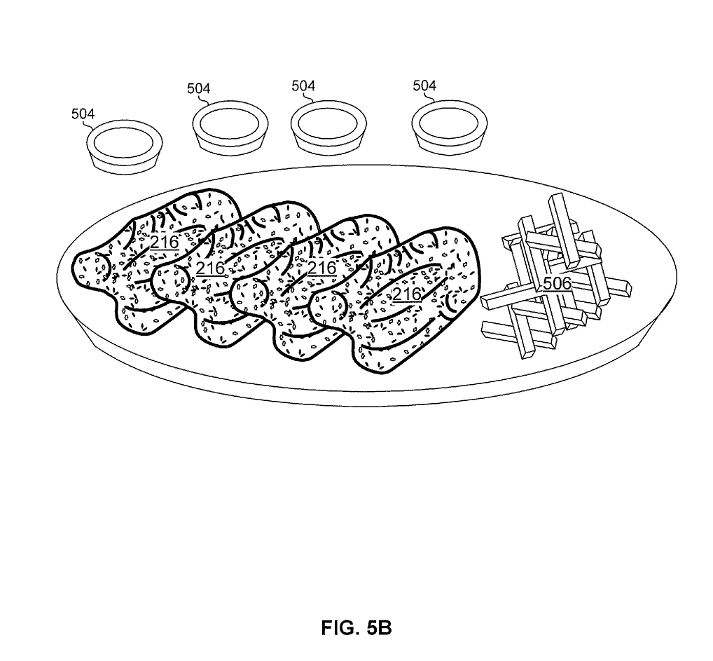

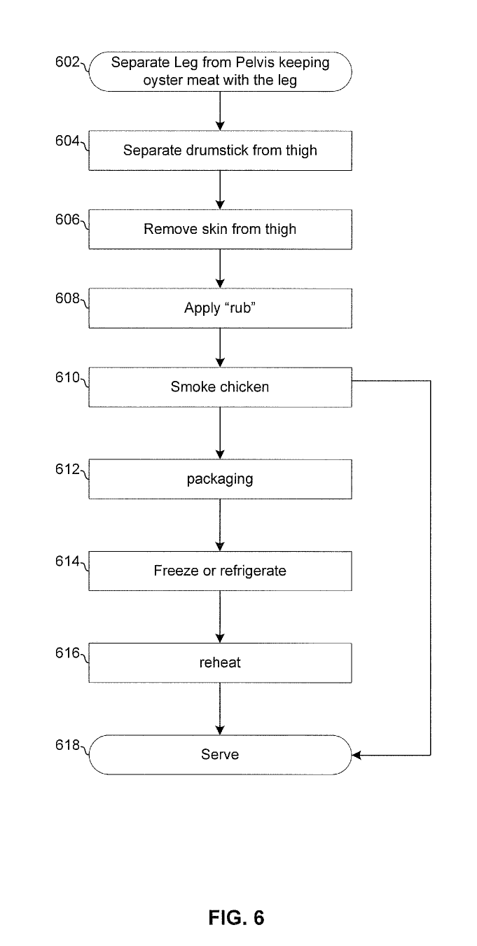

FIG. 6 is a flow chart illustrating exemplary steps for preparing a chicken thigh product, in accordance with an embodiment of the invention. Referring to FIG. 6, the exemplary steps may begin with step 602 in which an uncooked chicken leg may be separated from the pelvis of the chicken carcass. The cut or removal of the leg may be such that the oyster meat remains attached to the leg. Subsequent to step 602, the exemplary steps may advance to step 604.

In step 604, the leg may be separated into a bone-in oyster-cut chicken thigh and a drumstick by cutting across the knee joint of the chicken leg. In this regard, the cut may be generally perpendicular to the femur bone of the chicken thigh. Subsequent to step 604, the exemplary steps may advance to step 606. In step 606, the skin may be removed resulting in a skinless bone-in oyster-cut chicken thigh. In this regard, although the skin is shown as being removed subsequent to steps 602, and 604, the skin may be removed any anytime before or during steps 602 and 604. Subsequent to step 606, the exemplary steps may advance to step 608.

In step 608, the skinless bone-in oyster-cut chicken thigh may be seasoned with one or more seasonings. The seasonings may comprise one or more herbs, spices, sauces, pastes, grains, fruits, vegetables, and/or any other seasoning ingredient. In an exemplary embodiment of the invention, the seasoning may be a mixture of substantially dry ingredients and may be referred to as a “rub”. The seasoning may be applied to the inner surface (near the bone) of the thigh, the outer surface (away from the bone) of the thigh and/or, may be injected into the thigh. Subsequent to step 608, the exemplary steps may advance to step 610.

In step 610 the seasoned skinless bone-in oyster-cut chicken thigh may be cooked by smoking it. In this regard, the chicken thigh may be cooked in a smoking apparatus commonly referred to as a “smoker.” In an exemplary embodiment of the invention, the chicken thigh may be smoked until a temperature of the thigh reaches at least 180° F., where the temperature of the chicken thigh is measured at approximately the center of approximately the thickest portion of the chicken thigh. Subsequent to step 610 the exemplary steps may advance to one of steps 612 and 618, depending on how the chicken thigh product will be offered for sale, to whom the chicken thigh product will be served, and/or when the chicken thigh product will be consumed.

After smoking, the chicken thigh product may have a taste and texture that imitates or is reminiscent of pork or beef ribs. Also, the manner of eating the chicken thigh meat from the thigh bone may be reminiscent of eating pork or beef from a rib bone. Thus, the taste, texture, and manner of eating the chicken thigh product may combine to create an experience substantially similar to eating pork or beef ribs.

In step 612, the chicken thigh product may be packaged. In various exemplary embodiments of the invention, the chicken thigh product may vacuum sealed in a bag. In various exemplary embodiments of the invention, the chicken thigh product may be packed into a container suitable for staking or display in, for example, a refrigerated display case. In various embodiments of the invention, the packaging may marked with a product or brand name that is reminiscent of pork or beef ribs. For example, the chicken thigh product may be marketed or offered for sale as Chicken Ribs™. Additionally, the packaging may indicate a quantity of chicken thigh products therein in units of slabs or half-slabs. In this regard, the marketing and packaging of the chicken thigh product may contribute to a dining experience that imitates or is reminiscent of eating pork or beef ribs. Subsequent to step 612, the exemplary steps may advance to step 614.

In step 614, the packed chicken thigh product may be refrigerated or frozen. In this manner, the refrigerated or frozen chicken thigh product may be kept from spoiling while being stored for later consumption and/or shipping. Subsequent to step 614, the exemplary steps may advance to step 616. In step 616, the refrigerated and/or frozen chicken thigh product may be reheated in, for example, a conventional oven, a microwave oven, or on a grill. In an exemplary embodiment of the invention, the chicken thigh product may be placed in an oven at approximately 350° until the chicken thigh product reaches a desired temperature for consumption. Subsequent to step 616, the exemplary steps may advance to step 618. In step 618, the chicken thigh product may be served in half slab portions, full slab portions, or some multiple or combination thereof, where a half slab may correspond to N chicken thigh products and a full slab may correspond to 2N chicken thigh products.

Aspects of a method and system for preparing a chicken thigh product are provided. In an exemplary embodiment of the invention, a chicken thigh product 216 may be prepared by seasoning and smoking a skinless bone-in oyster-cut chicken thigh 116, where the skinless bone-in oyster-cut chicken thigh 116 comprises a thigh bone 104, thigh meat 112, and oyster meat 102. Preparing the chicken thigh product 216 may comprise separating an uncooked chicken leg 100 from an uncooked chicken carcass such that the oyster meat 102 is separated from the pelvis of the uncooked chicken carcass and remains attached to the uncooked chicken leg 100. Preparing the chicken thigh product 216 may comprise cutting across the knee joint 120 of a chicken leg 100 such that the chicken leg 100 is separated into a bone-in oyster-cut chicken thigh 116 and a drumstick 118. Preparing the chicken thigh product may comprise removing any skin from a bone-in oyster-cut chicken thigh 116.

The skinless bone-in oyster-cut chicken thigh 116 may be smoked until an internal temperature of the oyster-cut chicken thigh is at least 180°. The chicken thigh product 216 may be frozen after smoking, and may be reheated in one of a conventional oven, a microwave oven, and a grill until said chicken thigh product is a desired temperature. The skinless bone-in oyster-cut chicken thigh 116 may be smoked until a texture of the skinless bone-in oyster-cut chicken thigh is substantially similar to the texture of cooked pork ribs. The chicken thigh product may be placed in a package that indicates a quantity of the chicken thigh products therein. The quantity may be indicated as an integer and/or fractional number of slabs, where a slab may correspond to a quantity of two or more of the chicken thigh products.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for preparing a chicken thigh product, the method comprising:
applying one or more seasonings to a skinless bone-in oyster-cut chicken thigh, where said skinless bone-in oyster-cut chicken thigh comprises a thigh bone, thigh meat, and oyster meat; and
smoking said skinless bone-in oyster-cut chicken thigh in a smoking apparatus.

2. The method according to claim 1, wherein said skinless bone-in oyster-cut chicken thigh is obtained by:
separating an uncooked chicken leg from an uncooked chicken carcass such that the oyster meat is separated from said pelvis of said uncooked chicken carcass and remains attached to said uncooked chicken leg;
cutting across the knee joint of said chicken leg such that said chicken leg is separated into an bone-in oyster-cut chicken thigh and a drumstick;
removing any skin from said bone-in oyster-cut chicken thigh.

3. The method according to claim 1, comprising smoking said skinless bone-in oyster-cut chicken thigh until an internal temperature of said oyster-cut chicken thigh reaches at least 180° F.

4. The method according to claim 1, comprising freezing said chicken thigh product.

5. The method according to claim 4, comprising reheating said chicken thigh product in one of a conventional oven, a microwave oven, and a grill until said chicken thigh product is a desired temperature.

6. The method according to claim 1, comprising smoking said skinless bone-in oyster-cut chicken thigh until a texture of said skinless bone-in oyster-cut chicken thigh is substantially similar to the texture of cooked pork ribs.

7. The method according to claim 1, comprising placing said chicken thigh product in a package that indicates a quantity of said chicken thigh products therein, wherein:
said quantity is indicated as an integer and/or fractional number of slabs, and
one of said slabs corresponds to a quantity of two or more of said chicken thigh products.

8. A chicken thigh product prepared by:
applying one or more seasonings to a skinless bone-in oyster-cut chicken thigh, where said skinless bone-in oyster-cut chicken thigh comprises a thigh bone, thigh meat, and oyster meat; and
smoking said skinless bone-in oyster-cut chicken thigh in a smoking apparatus.

9. The method according to claim 1, wherein said skinless bone-in oyster-cut chicken thigh is obtained by:
separating an uncooked chicken leg from an uncooked chicken carcass such that the oyster meat is separated from said pelvis of said uncooked chicken carcass and remains attached to said uncooked chicken leg;
cutting across the knee joint of said chicken leg such that said chicken leg is separated into an bone-in oyster-cut chicken thigh and a drumstick;
removing any skin from said bone-in oyster-cut chicken thigh.

10. The method according to claim 9, comprising smoking said skinless bone-in oyster-cut chicken thigh until an internal temperature of said oyster-cut chicken thigh reaches at least 180°.

11. The method according to claim 9, comprising freezing said chicken thigh product.

12. The method according to claim 11, comprising reheating said chicken thigh product in one of a conventional oven, a microwave oven, and a grill until said chicken thigh product is a desired temperature.

13. The method according to claim 9, comprising smoking said skinless bone-in oyster-cut chicken thigh until a texture of said skinless bone-in oyster-cut chicken thigh is substantially similar to the texture of cooked pork ribs.

14. The method according to claim 9, comprising placing said chicken thigh product in a package that indicates a quantity of said chicken thigh products therein, wherein:
said quantity is indicated as an integer and/or fractional number of slabs, and
one of said slabs corresponds to a quantity of two or more of said chicken thigh products.

15. A method for selling chicken thighs, the method comprising:
preparing a chicken thigh product that has a taste and texture that imitates pork or beef ribs;
marketing said chicken thigh products under a product name that references or implies pork ribs or beef ribs;
selling said chicken thigh products in integer or half-integer multiples of a slab.

16. The method according to claim 15, wherein said preparing comprises cutting, seasoning, and smoking a chicken thigh.

17. The method according to claim 16, wherein oyster meat is kept attached to said chicken thigh during said cutting.
